(19) United States
(12) Patent Application Publication
(10) Pub. No.: US 2024/0305394 A1
(43) Pub. Date: Sep. 12, 2024

(54) TIME SENSITIVE NETWORKING OVER WI-FI

(71) Applicant: MaxLinear, Inc., Carlsbad, CA (US)

(72) Inventors: Sigurd Schelstraete, Menlo Park, CA (US); Marcos Martínez Vázquez, Barcelona (ES); Iñaki Val Beitia, Vitoria (ES)

(73) Assignee: MaxLinear, Inc., Carlsbad, CA (US)

(21) Appl. No.: 18/602,005

(22) Filed: Mar. 11, 2024

Related U.S. Application Data
(60) Provisional application No. 63/489,702, filed on Mar. 10, 2023.

(51) Int. Cl. H04J 3/06; H04L 5/00; H04W 56/00

(52) U.S. Cl. CPC H04J 3/0644; H04L 5/0007; H04W 56/0015

(57) ABSTRACT

This disclosure describes a system for applying precise timing to a mesh wireless Wi-Fi network. The precise timing allows for multiple access points (APs) to serve a single station (STA) when the STA is located in a wireless footprint of more than one access point without the need for a wireless trigger frame. Various examples are described including the use of orthogonal frequency division multiple access (OFDMA), time division multiple access (TDMA) and multi-access point joint transmission.

### CROSS-REFERENCE TO RELATED APPLICATIONS

This application claims priority to U.S. Provisional Patent Application No. 63/489,702 filed on Mar. 10, 2023 and entitled “TIME SENSITIVE NETWORKING OVER WI-FI”, which is incorporated by reference in its entirety.

### TECHNICAL FIELD

This disclosure relates to wireless communication, and more specifically, to time sensitive networking over Wi-Fi.

### BACKGROUND

Institute of Electrical and Electronics Engineers (IEEE) 802.11 standards include protocols for implementing various networking techniques, including wireless local area network (WLAN) communications and Wi-Fi. Users and the applications they work with on a daily basis are continuously expecting faster connectivity speeds and greater reliability. Consequently, innovations helping with connectivity speed and reliability are desirable.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

This paper describes various embodiments that relate to time sensitive networking, including some implementations for operating over a wireless mesh Wi-Fi network.

A system may include two or more access points to provide a wireless network, the two or more access points including a first access point configured to synchronize a global clock signal across the two or more access points, wherein the two or more access points are configured to initiate transmit operations based on the synchronized global clock.

An access point may include: a transceiver configured to receive and transmit signals to two or more access points to provide a wireless network; a wired communication port; and a processor configured to receive a timing signal over the wired communication port from a network terminal; synchronize a global clock signal with the timing signal; and transmit the synchronized global clock signal to two or more other access points contributing to the wireless network.

### BRIEF DESCRIPTION OF THE DRAWINGS

Example embodiments will be described and explained with additional specificity and detail through the use of the accompanying drawings in which:

FIG. 1 shows an exemplary household filled with a variety of electronic devices or stations (STAs) connected to a Wi-Fi network generated by a cable modem and an access point;

FIG. 2 shows an exemplary mesh network configuration with a hybrid backhaul suited to benefit from the global time synchronization mechanism;

FIGS. 3A-3C show various ways in transmission opportunities (TXOPs) can be scheduled in a Multi-access point (AP)/Mesh/Repeater environment;

FIG. 4 shows an exemplary residential configuration in which mechanisms such as Multi-AP Joint Transmission and Distributed multiple input, multiple output (MIMO) require accurate time and radio frequency (RF) carrier frequency synchronization between two access points;

FIG. 5 shows a wireless configuration in which a first AP is responsible for synchronizing timing for two other APs;

FIG. 6A shows a network that includes several repeater devices or APs connected by wireless and/or wired links;

FIG. 6B shows a scheduled plan for multiple flows from the network depicted in FIG. 8A;

FIGS. 7A-7D show graphs illustrating exemplary traffic patterns for three different streaming providers;

FIG. 8 shows how a number and rate of change in data segments being delivered over time varies by streaming provider;

FIG. 9A shows an exemplary network that includes a wireless gateway and an AP;

FIG. 9B shows a scheduled plan for flows depicted in FIG. 9A;

FIG. 10A shows a network that includes a wireless gateway 1002 in wireless communication with multiple exemplary STAs and connected via a wired link to a network terminal;

FIG. 10B shows a specific configuration in which the wireless gateway shown in FIG. 10A is running on an optical network, such as a passive optical (PON) network;

FIG. 11 illustrates a diagrammatic representation of a machine in the example form of a computing device; and

FIG. 12 illustrates a flowchart of an example method 1200 of one or more time synchronization operations, in accordance with at least one embodiment of the present disclosure.

### DETAILED DESCRIPTION

Time Sensitive Networking (TSN) is a collection of IEEE 802.1 standards that manage the network devices for allowing traffic flows to meet some specific time-related requirements. For example, TSN can help prioritize time-sensitive data packets, guaranteeing delivery within a specific timeframe.

In particular, the described embodiments provides details on how to fully integrate IEEE 802.1AS time synchronization over IEEE 802.11, which allows for the implementation of time-triggered events for multi-user, coordinated and joint operation. The described embodiments, also allow for time-triggered events for restricted Target Wake Time (rTWT) execution.

A traffic flow (or stream) follows a repetitive pattern with specific features (e.g. traffic interval period) and requirements (e.g. end-to-end (E2E) latency), where the data traffic arrives periodically along the time with defined characteristics.

A home environment may include several electronic devices (e.g., PCs, laptops, TVs, smartphones, tablets, cameras, Internet of Things (IoT) devices, controllers/hubs, smart lighting, connected toys, connected photo frames, connected speakers, connected sleep sensors, connected health/monitoring devices, video doorbells, connected electrical switches, connected weather stations etc.) connected to the Wi-Fi network, accessing simultaneously external and internal services.

### TSN and Home Networking

TSN provides benefits for many different applications including industrial control systems and autonomous vehicles. TSN can also be of benefit to real-time audio/video streaming, gaming (cloud and online games), home surveillance, video calls, IoT devices, etc.

TSN can be used for various purposes, including to analyze different data usage traffic patterns in order to extract their main features, showing predictable and repetitive behavior. In some embodiments, these extracted main features can be used to predict an incidence of predictable data traffic crossing a particular medium.

Some specific traffic features and requirements are related to: average interval period, average throughput, average packet length, priority, and maximum end-to-end latency. In some embodiments, traffic characteristic can be inferred in real-time by a software integrated in a residential gateway. Traffic meeting a predetermined pattern or having one or more characteristics can be tagged by the gateway for further analysis and/or tracking.

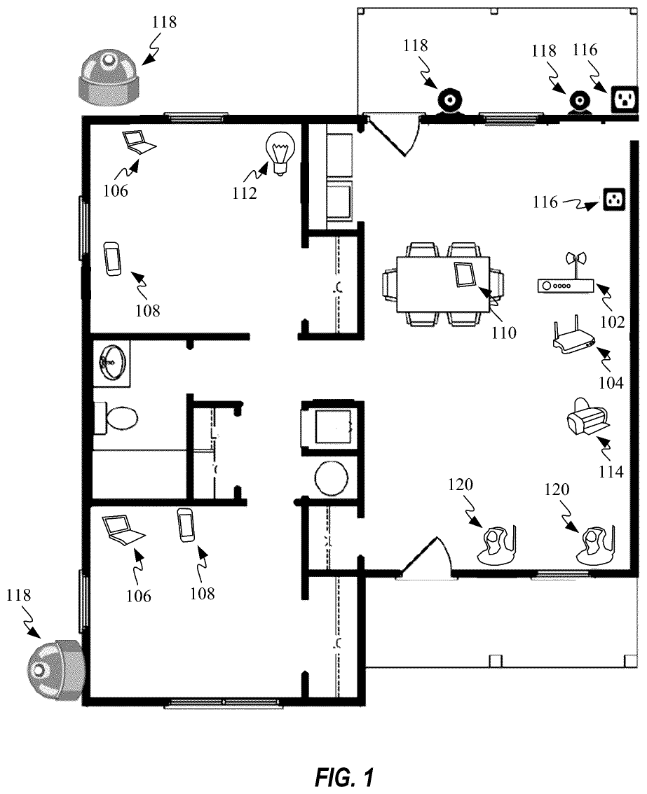

FIG. 1 shows an exemplary environment that includes a variety of electronic devices or STAs connected to a Wi-Fi network generated by cable modem 102 and access point 104. Exemplary STAs are depicted and include multiple laptops 106, multiple smartphones 108, a tablet 110, a smart bulb 112, a printer 114, multiple connected electrical switches 116, multiple outdoor security cameras 118 and multiple indoor security cameras 120, but can include any number or type of electronic device that can connect to a wireless network. Because of the large number of STAs and because many of the STAs are produced by different companies/manufacturers some conflicts may occur, which might lead to conflicts and/or dropped packets.

One of the main features of TSN is the time synchronization mechanism (IEEE 802.1AS-2020), which enables a common time reference for the network: the network can execute time-triggered actions. The time synchronization mechanism is referred to generally as precision time protocol (PTP).

IEEE 802.11 already had a simple synchronization mechanism known as a Time Synchronization Function (TSF), but when using TSF the AP only synchronizes the associated STAs, there is no propagation of the time over a Mesh/Repeater network, or other network technologies (e.g., power line communication (PLC), Ethernet).

IEEE 802.1AS-2020 partially defines a time synchronization feature for IEEE 802.11 but the feature is deficient for a number of reasons. For example, the time synchronization feature for IEEE 802.11 is missing a reference architecture for designing and integrating the PTP Hardware Clock and RX/TX timestamping units; and a full definition of exchanged frames, compliant with PTP. Consequently, introducing a global time synchronization mechanism enables new features and/or enhances existing ones.

At the media access control (MAC) level the time synchronization mechanism enables simultaneous TXOPs originating at non-collocated transmitters_and restricted Target Wake Time (rTWT) windows in a network, optimizing the use of the radio resources.

At the physical (PHY) level: the time synchronization mechanism enables synchronization of RF local oscillator phase-locked loops (PLLs) for better Multi-AP and distributed MIMO performance.

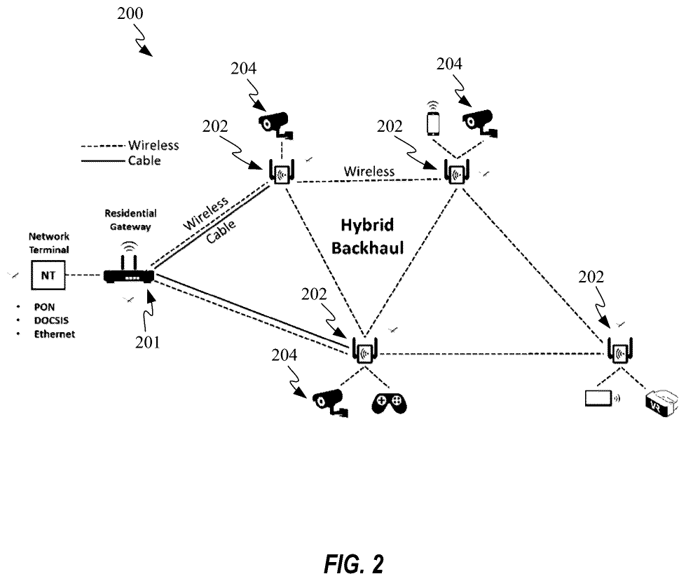

FIG. 2 shows an exemplary mesh network configuration 200 with a hybrid backhaul suited to benefit from the global time synchronization mechanism. In particular, mesh network configuration 200 is generated by a router or residential gateway 201 and multiple access points 202. The network configuration 200 supports multiple security cameras 404 and other assorted STAs, for example.

Time synchronization over the air has the following options listed in Table (1) below. As shown by Table (1) enhanced time synchronization methods provide substantial benefits in accuracy over the currently available TSF mechanism. As is shown below, the Fine Timing Management (FTM) protocol, designed for locating IoT sensors is can also be leveraged to perform time synchronization to high levels of accuracy, as demonstrated by the numbers below. The FTM protocol involves communication with one or more STAs to perform a synchronization process. Performing this synchronization process in a multi-AP environment to locate sensors can in addition to locating IoT sensors also be used to synchronize a global clock across a WiFi network.

TABLE (1)

| Mechanism | Technique | Accuracy | Applicable to: |
|---|---|---|---|
| Current TSF | Beacon Frame | 1-10 | Coordinated- |
| | | microseconds | TDMA |
| Enhanced TSF | Beacon Frame | Around 100 | Coordinated- |
| | | nanoseconds | OFDMA |
| | | | Coordinated- |
| | | | TDMA |
| FTM - Without | Full PTP | 1-10 | Coordinated- |
| Wireless channel | | nanoseconds | OFDMA |
| state information | | | Coordinated- |
| | | | TDMA |
| FTM - With | Full PTP | Around 500 | Coordinated- |
| Wireless channel | | picoseconds | OFDMA |
| state information | | | Coordinated- |
| | | | TDMA |
| | | | Coordinated- |
| | | | Joint |
| | | | Transmission |

### MAC-Level Time Synchronization

There are numerous enhancements related to the use of a common clock at MAC level:

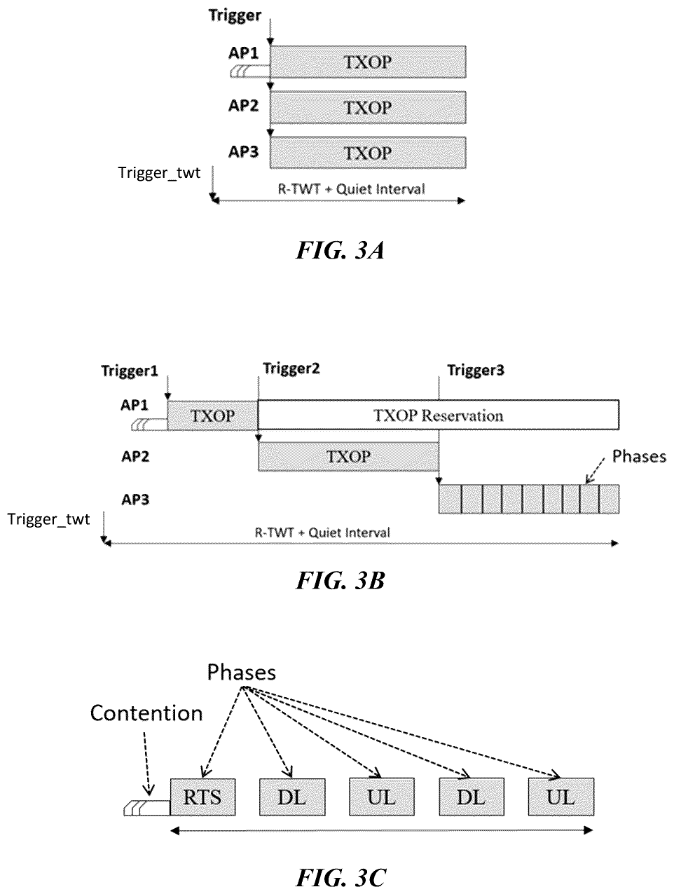

FIGS. 3A-3C show how in a Multi-AP/Mesh/Repeater environment, several TXOPs can be scheduled in various ways. FIG. 3A shows how several TXOPs can be scheduled concurrently by triggering AP1, AP2 and AP3 to begin TXOPs at the same time. Such a configuration can be applied when using coordinated orthogonal frequency division multiple access (OFDMA or coordinated joint transmission (JTX) protocols.

FIG. 3B shows a time division multiple access (TDMA) implementation that includes a series of cascaded accesses performed by AP1, AP2 and AP3 can be mastered by AP1. As shown in FIG. 3B by the minimal gaps between the end of one TXOP and the beginning of the next one, the global common clock allows for spacing intervals between the cascaded TXOPs to be minimized thereby reducing transfer latency. Reducing the latency results in a reduced need for memory buffering in the network (including at one or both the repeaters and STAs). Some jitter between the TXOPs can arise due to the variable delay of AP1 contention but this delay is generally minor enough not to have a substantial degradation on performance. The sequence of TXOPs is repeated along the time servicing access to the periodic traffic flows. Each TXOP is composed of pre-planned (Plan) scheduled basic accesses designed to avoid repetitive traffic patterns and/or a regular series of phases: request to send (RTS), uplink (UL), downlink (DL), etc. as depicted in FIG. 3C.

The STAs may be driven by the AP, where a respective STA's access to medium is limited by the rTWT configuration. For this reason, the STA does not need time synchronization.

### PHY-Level Time Synchronization

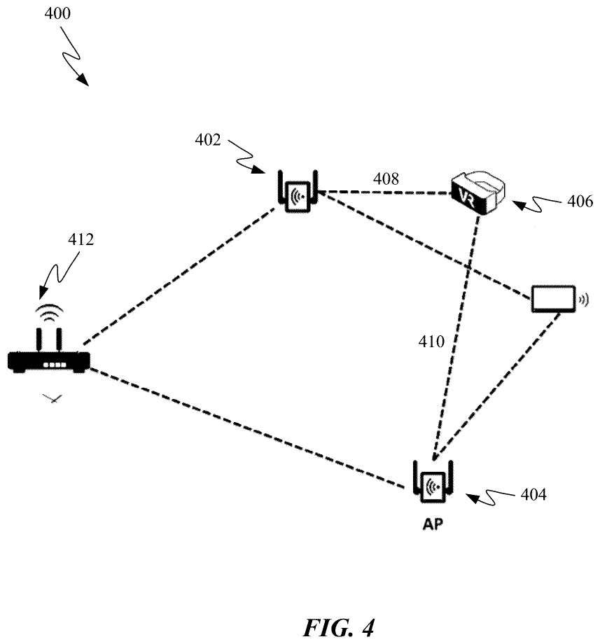

FIG. 4 shows an exemplary residential configuration 400 in which mechanisms such as Multi-AP Joint Transmission (JTX) and Distributed MIMO require accurate time and RF carrier frequency synchronization between an AP 302 and an AP 304. In this scenario, a STA 306, taking the example form of a VR headset, receives two different signals at the same time from APs 602 and 604, indicated by signal transmission lines 608 and 610. In this configuration, residential gateway 612 can be responsible for synchronizing a global common clock with APs 602 and 604 that allows for the timely arrival of signals at STA 606. As with previous examples, the clock synchronization can be performed over a wired or wireless medium. A wired backhaul may implement Ethernet or PLC technology implementing PTP mechanism (e.g., IEEE 802.1AS) while a wireless backhaul may be implemented using an 802.11 FTM mechanism (e.g., under PTP IEEE 802.1AS). The use of Multi-AP joint transmission (JTX) provides many advantages including increasing overall signal to noise ratio (SNR) gain, which also increases the spatial diversity of the transmission. Because the APs are synchronized using the backhaul direct communication isn't required to achieve positive synchronization in some embodiments.

While FIG. 4 illustrates a residential or home networking configuration it should be appreciated that hotels/conference centers, hospitals, enterprise, offices, factories and airports can all benefit from the increased accuracy achieved using the aforementioned techniques. Most of the use cases apply a typical network architecture based on the distribution of APs along different floors in order to achieve consistent wireless coverage.

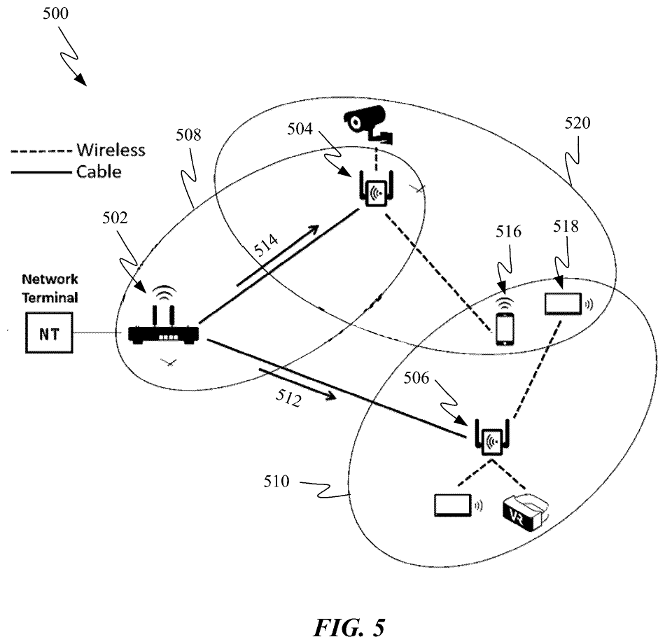

FIG. 5 shows a wireless configuration 500 in which a first AP 502 is responsible for synchronizing timing for AP 504 and AP 506. FIG. 5 also shows how a first wireless footprint 508 of first AP 702 does not overlap directly with a second wireless footprint 510 of AP 506. In this configuration, a wired backhaul that includes synchronization lines 512 and 514 allows for high speed timing synchronization to be performed directly between AP 502 and APs 504 and 506 regardless of overlap in wireless footprints.

When STAs 516 and 518 operate within an overlapping portion of wireless foot prints 510 and 520, as depicted, APs 504 and 506 can apply coordinated OFDMA protocols in order to efficiently supply connectivity to STAs 516 and 518 without communicating directly between each of the APs 504 and 506 (e.g., without communication between the APs 504 and 506). The coordinated OFDMA protocols can be synchronized using the global common clock signal, which allows for transmissions to be time triggered events rather than needing to rely on one or more wireless trigger frames to initiate TXOPs. In this way, a use of radio resources in the overlapped area can be optimized. In some embodiments, use of time synchronization together with wired backhaul can reduce the AP density needed to sufficiently cover a particular area.

While the configuration shown in FIG. 5 was described using a wired backhaul, it should be appreciated that a wireless backhaul, or a hybrid wireless/wired backhaul could alternatively be used. Use of a wireless backhaul would generally have APs involved to be able to communicate with the AP responsible for initiating a trigger frame.

### Coordinated TDMA Operations

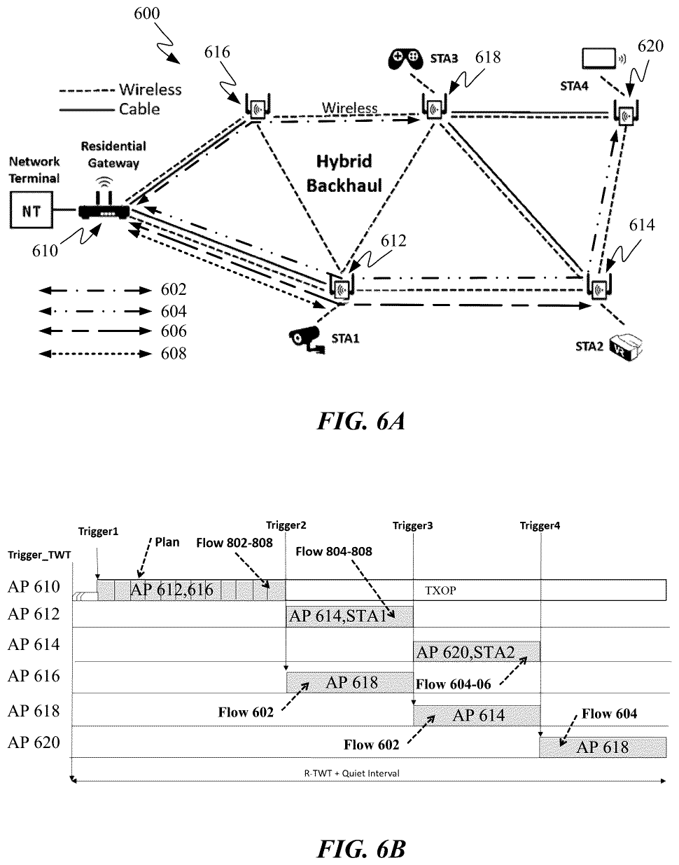

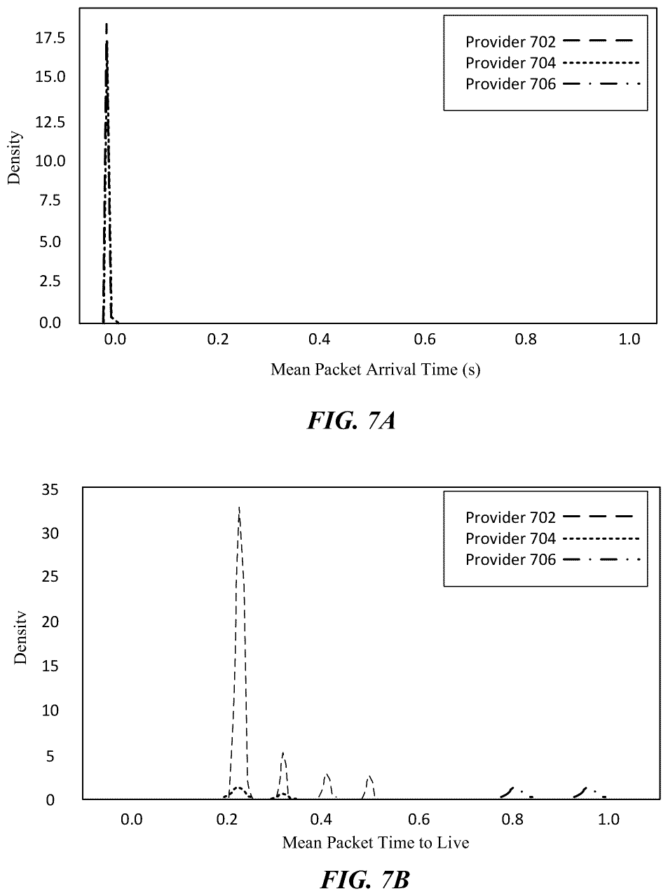

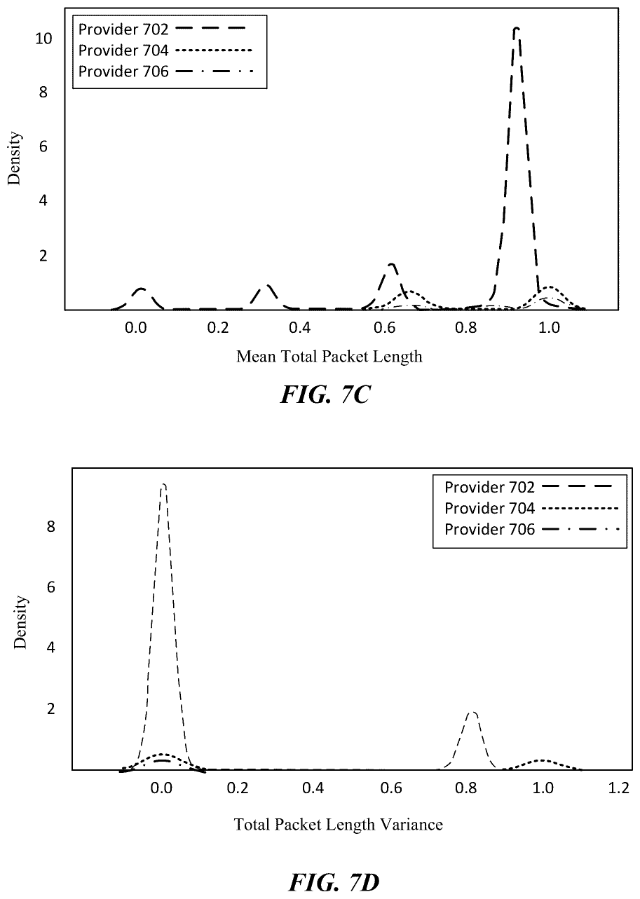

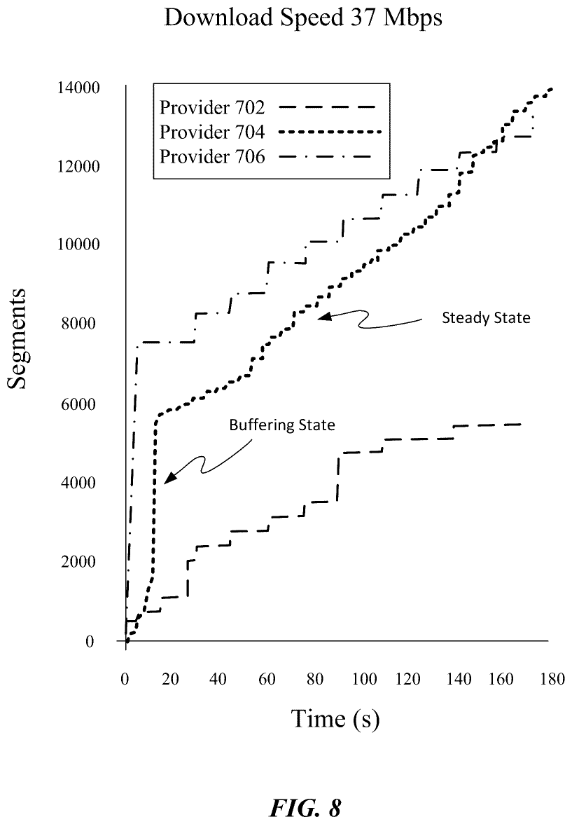

FIG. 6A shows a network 600 that includes several repeater devices or APs connected by wireless and/or wired links. Several network service flows 602-608 with a traffic pattern or patterns following some characteristics, such as repetitive behavior are depicted. Flow 802 runs between AP 610 and AP 618 by way of AP 616. Flow 604 runs between AP 610 and AP 614 by way of AP 612. Flow 606 also runs between AP 610 and AP 614 by way of AP 612. Flow 608 runs between AP 610 and AP 612. These repetitive behaviors can be similar in nature to the repetitive behaviors depicted below in FIGS. 7A-8. Each traffic flow has specific requirements and a specific path to reach a respective destination. In a conventional network, the traffic is sent to each hop without coordination between the repeaters, resulting in a lack of control over end to end latency and buffering of intermediate frames. Applying the aforementioned time synchronization methods allows for the creation precisely timed, time-triggered events along the whole network, thereby facilitating substantial increases in coordination without loss of timing accuracy.

FIG. 6B shows a scheduled plan for flows 602-608 from network 600 as shown in FIG. 6A. In particular, each depicted segment or hop may be coordinated with the transactions of the rest of the AP links. The STA may respond to their AP, or the STA may also maintain its silence due to the rTWT configuration. After rTWT is time-triggered each AP plan is activated sequentially, which creates a double TDMA mechanism. A configuration mechanism can be defined for setting up all the APs with their trigger times and schedulers. The configuration mechanism is operative to position the TXOPs at times unlikely to conflict with other transmissions. In some embodiments, this can be accomplished by coordination between APs and in other embodiments a history of transmissions can be considered when planning where to place TXOPs.

FIGS. 7-A through FIG. 8 illustrate various traffic patterns that may be used herein for various embodiments. For example, in looking at traffic patterns, the systems and methods described herein can determine periods of routine traffic. And, the systems and methods described herein can determine to process new signals that are received during time periods that are known to be free of use by routine network traffic. In some embodiments, an access point is configured to monitor network traffic for routine network traffic and then schedule uncommon network traffic transmissions during times falling outside an expected time period where the routine network traffic is received or expected.

FIGS. 7A-7D show graphs illustrating exemplary traffic patterns for three different streaming providers. In particular, FIG. 7A shows mean or average packet arrival times are substantially uniform across the streaming providers and near zero. FIG. 7B shows mean packet time to live. In FIG. 7B we see that packet time to live is substantially longer for provider three than for providers one and two. FIG. 7C shows mean total packet length. Here we see that provider 102 has much more variance than providers 704 and 706. More specifically provider 102 has mean packet lengths concentrated into four different distributions. FIG. 7D shows how a length variance is substantially consistent across the three different streaming providers. Together this data allows for accurate prediction of when streaming services are likely to occupy bandwidth during operation. This allows access points to mitigate any interference by scheduling TXOPs outside the standard operating windows.

FIG. 8 shows how a number and rate of change in data segments being delivered over time varies by provider. These results were all measured on a connection with download speeds of about 37 Mbps. It should be noted that, providers two and three have distinct buffering states and steady states of operation, while provider one has implemented an abbreviated buffering state with intermittent buffering stages arranged along playback of a media file.

The complete scenario is composed of several traffic flow services executed at the same time and on the same network, where the entry point is the residential gateway, where the traffic is tagged for further analysis. Each service has its own requirement that should be met for an optimal user experience (QoE and QoS). All these traffic flows need to coexist with sporadic event traffic, such as web navigation, Office365 tools, etc. Each traffic flow needs to be classified (tagged) according to its requirements and criticality. The STA devices don't need to implement TSN, just follow the commanded transactions from their AP. TSN tries to offer the tools for orchestrating all the needed mechanism necessary to create the optimal user experience.

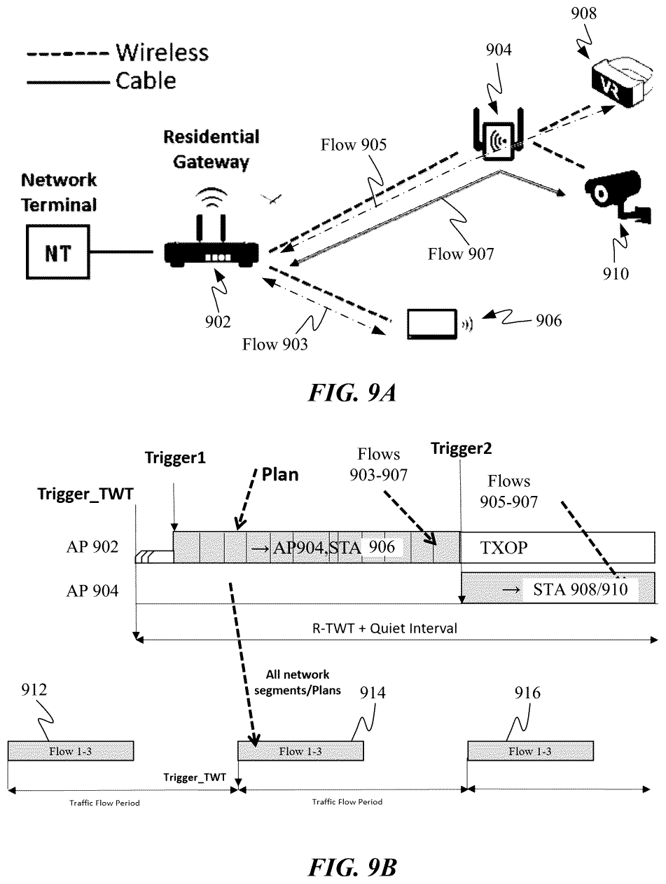

FIG. 9A shows an exemplary network 900 that includes a wireless gateway 902 and an AP 904. In some embodiments, wireless gateway can be configured to communicate to an exterior network such as the internet using data over cable service interface specification (DOCSIS) protocols or by way of a passive optical network (PON). Wireless gateway 902 is in communication with AP 904 and STA 906, while AP 904 is also in communication with STA 908 and STA 910. The double headed arrows depict three flows 903, 905, 907 with a traffic pattern following some repetitive traffic pattern similar to one or more of the ones shown in FIGS. 7A-8.

FIG. 9B shows a scheduled plan for flows 903-907 depicted in FIG. 9A. A lower portion of FIG. 9B also shows blocks 906-910 illustrating how each set of flows can be separated and positioned to correspond to free airtime within a respective traffic-flow period. This is generally determined by locating or identifying time periods not otherwise occupied by the repetitive patterns of communication.

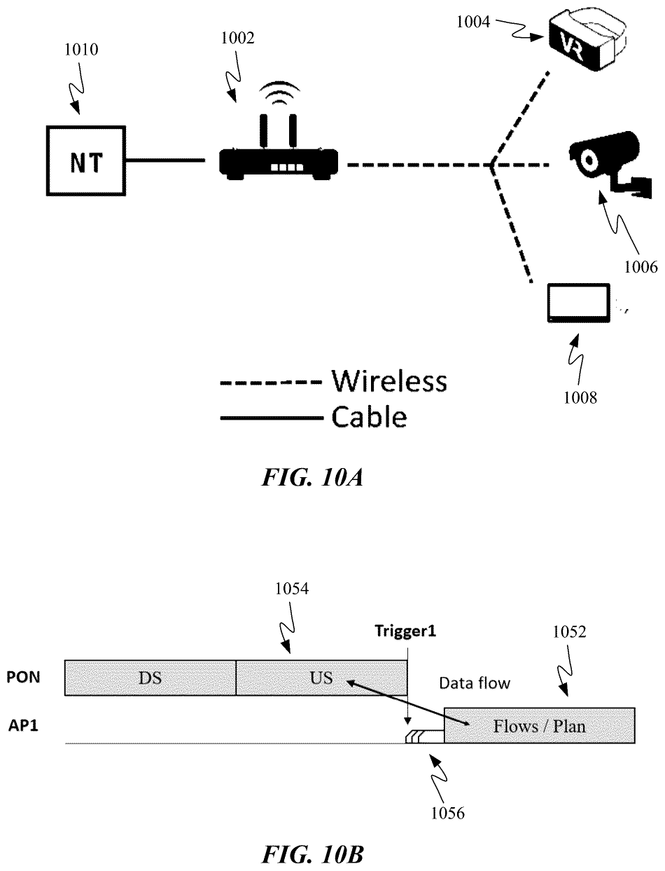

FIG. 10A shows a network 1000 that includes a wireless gateway 1002 in wireless communication with multiple exemplary STAs 1004-1008 and connected via a wired link to a network terminal 1010. In addition to generating and synchronizing a global common clock signal with STAs 1004-1008, wireless gateway 1002 can be further configured to synchronize the global common clock with a synchronization mechanism of network terminal 1010. This further improves performance and helps to improve end to end quality of service for the wireless mesh network. This provide improvements, as history of activity data gathered from outside the wireless mesh network would be inaccurate if the global common clock signal were out of sync with the network terminal. As network terminals commonly run using DOCSIS or a PON.

FIG. 10B shows a specific configuration in which wireless gateway 1002 is connected to and exchanging data with a PON. As depicted in region 1056, timing is synchronized such that a contention period preceding the flows/plan block 1052 begins at the end of the upstream block 1054 of the PON. Utilizing the aforementioned timing synchronization techniques helps achieve consistent operation and synchronization of network operation with outside network operations.

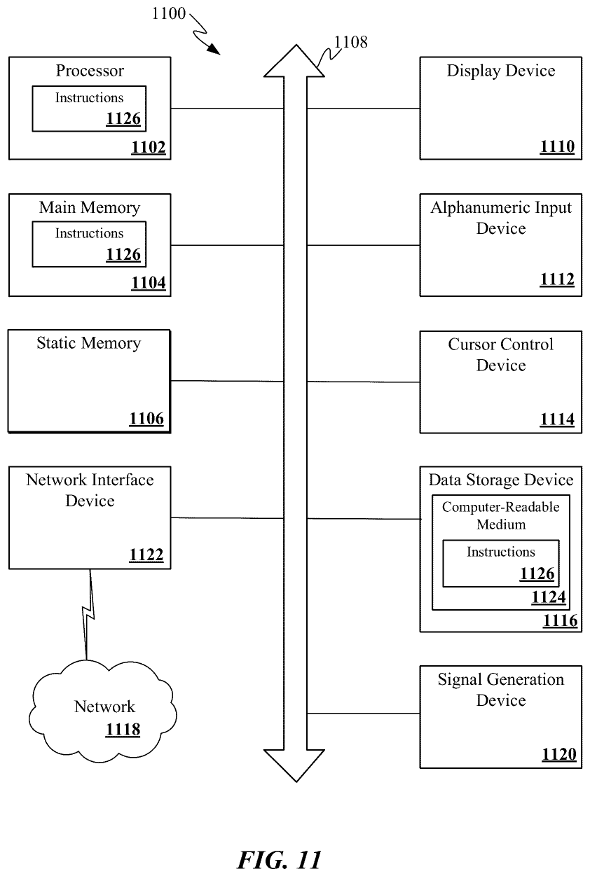

FIG. 11 illustrates a diagrammatic representation of a machine in the example form of a computing device 1100 within which a set of instructions, for causing the machine to perform any one or more of the operations discussed herein, may be executed. The computing device 1100 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1100 includes a processing device (e.g., a processor) 1102, a main memory 1104 (e.g., read-only memory (ROM), flash memory, dynamic random access memory (DRAM) such as synchronous DRAM (SDRAM)), a static memory 1106 (e.g., flash memory, static random access memory (SRAM)) and a data storage device 1116, which communicate with each other via a bus 1108.

Processing device 1102 represents one or more processing devices such as a microprocessor, central processing unit, or the like. More particularly, the processing device 1102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also include one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computing device 1100 may further include a network interface device 1122 which may communicate with a network 1118. The computing device 1100 also may include a display device 1110 (e.g., a liquid crystal display (LCD) or a cathode ray tube (CRT)), an alphanumeric input device 1112 (e.g., a keyboard), a cursor control device 1114 (e.g., a mouse) and a signal generation device 1120 (e.g., a speaker). In at least one embodiment, the display device 1110, the alphanumeric input device 1112, and the cursor control device 1114 may be combined into a single component or device (e.g., an LCD touch screen).

The data storage device 1116 may include a computer-readable storage medium 1124 on which is stored one or more sets of instructions 1126 embodying any one or more of the methods or functions described herein. The instructions 1126 may also reside, completely or at least partially, within the main memory 1104 and/or within the processing device 1102 during execution thereof by the computing device 1100, the main memory 1104 and the processing device 1102 also constituting computer-readable media. The instructions may further be transmitted or received over a network 1118 via the network interface device 1122.

While the computer-readable storage medium 1126 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

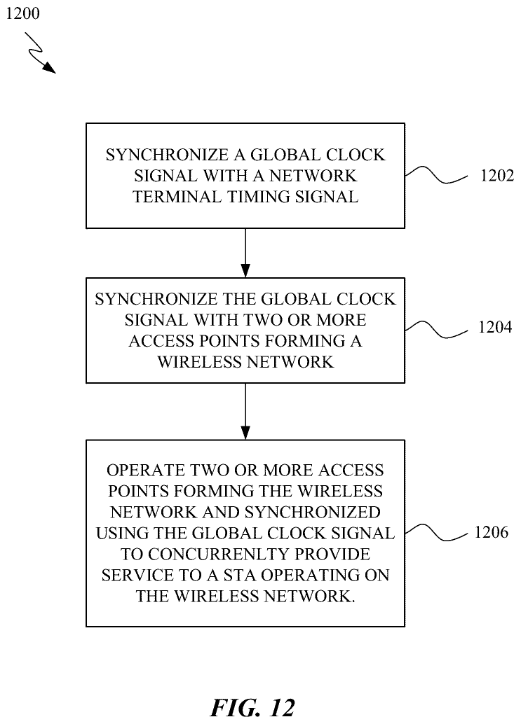

FIG. 12 illustrates a flowchart of an example method 1200 of one or more time synchronization operations, in accordance with at least one embodiment of the present disclosure. The method 1200 may be performed by processing logic that may include hardware (circuitry, dedicated logic, etc.), software (such as is run on a computer system or a dedicated machine), or a combination of both, which processing logic may be included in any computer system or device supporting any of the embodiments described in FIGS. 1-11.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 1202, processing logic may include synchronizing a global clock signal with a network terminal timing signal.

At block 1204, the processing logic may prior to or subsequent to the synchronization with the terminal timing signal transmit the global clock signal with two or more access points forming a mesh wireless network.

At block 1206, the processing logic may operate two or more access points forming the mesh wireless network and synchronized using the global clock signal to concurrently providing service to a STA operating on the mesh wireless network.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system, comprising:
a plurality of access points generating a wireless network, the plurality of access points comprising a first access point configured to synchronize a global clock signal across the plurality of access points, wherein the plurality of access points are configured to initiate transmit operations based on the synchronized global clock.

2. The system of claim 1, wherein the first access point is a wireless gateway and the other access points of the plurality of access points are repeaters.

3. The system of claim 1, further comprising a wired backhaul linking the plurality of access points, wherein the global clock signal is synchronized using the wired backhaul.

4. The system of claim 1, wherein the global clock signal is also synchronized with a clock associated with a data over cable service interface specification (DOCSIS) protocol being used to provide internet connectivity to the wireless network.

5. The system of claim 1, wherein the plurality of access points are configured to conduct coordinated orthogonal frequency division multiple access (OFDMA) operations in areas of the wireless network where at least a second access point and a third access point of the plurality of access points have overlapping coverage.

6. The system of claim 5, wherein the coordinated OFDMA operations are performed without communication between the second and third access points.

7. The system of claim 1, wherein the plurality of access points are configured to conduct coordinated time division multiple access (TDMA) operations in areas of the wireless network where at least a second access point and a third access point of the plurality of access points have overlapping coverage.

8. The system of claim 7, wherein the TDMA operations are performed without communication between the second and third access points.

9. The system of claim 1, wherein the plurality of access points are configured to conduct multi-AP joint transmission (JTX) operations in areas of the wireless network where at least a second access point and a third access point of the plurality of access points have overlapping coverage and wherein the multi-AP JTX operations are coordinated based on the global clock signal.

10. The system of claim 9, wherein the JTX operations are performed without communication between the second and third access points.

11. The system of claim 9, wherein the JTX operations include time and frequency synchronization between the second and third access points based on the global clock signal.

12. The system of claim 1, wherein new signals received on the wireless network are processed during time periods that are known to be free of use by routine network traffic.

13. The system of claim 1, wherein the first access point is configured to monitor network traffic for routine network traffic and then schedule uncommon network traffic transmissions during times falling outside an expected time period where the routine network traffic is received.

14. An access point, comprising:
a transceiver configured to receive and transmit signals to a plurality of access points to provide a wireless network;
a wired communication port; and
a processor configured to receive a timing signal over the wired communication port from a network terminal; synchronize a global clock signal with the timing signal; and transmit the synchronized global clock signal to a plurality of other access points contributing to the wireless Network.

15. The access point of claim 14, wherein the wired communication port is a first wired communication port and the access point further comprises a second wired communication port and a third wired communication port.

16. The access point of claim 15, wherein the plurality of access points comprises a first access point electrically coupled to the second wired communication port and a second access point electrically coupled to the third wired communication port.

17. The access point of claim 16, wherein the access point is configured to synchronize the global clock signal with the first and second access points using the second and third wired communication ports.

18. The access point of claim 14, wherein the access point is configured to conduct coordinated orthogonal frequency division multiple access (OFDMA) operations with one or more access points of the plurality of access points.

19. The access point of claim 14, wherein the access point is configured to conduct coordinated time division multiple access (TDMA) operations with one or more access points of the plurality of access points.

20. The access point of claim 14, wherein the access point is configured to conduct multi-AP joint transmission (JTX) operations with one or more access points of the plurality of access points.
